(19) United States
(12) Patent Application Publication
(10) Pub. No.: US 2002/0030749 A1
(43) Pub. Date: Mar. 14, 2002

(54) Image capturing apparatus

(76) Inventors: Hideo Nakamura, Suwa-shi (JP); Urato Aruga, Suwa-shi (JP)

Correspondence Address: Thomas R. Morrison, Esq., MORRISON LAW FIRM, 145 North Fifth Avenue, Mount Vernon, NY, 10550, US

(21) Appl. No.: 09/820,154

(22) Filed: Mar. 28, 2001

(30) Foreign Application Priority Data
Sep. 12, 2000 (JP) 2000-277093

(51) Int. Cl. H04N 5/228

(52) U.S. Cl. 348/220; 348/222

(57) ABSTRACT

A digital camera senses still images on a first image capturing device and moving images on a second image capturing device. The first and second image capturing devices have different characteristics adapted to their respective uses. The images from the second image capturing device are usable as a view finder for framing the image for the first image capturing device, as well as for performing preliminary measurements for use by the first image capturing device. The second image capturing device is of a type which permits omitting unneeded pixels, thereby reducing electric power consumption. In one embodiment, the optical axis is the same for the first and second image capturing devices, thereby eliminating parallax. In another embodiment, two displaced optical axes are used. Parallax is eliminated by processing the output of one of image capturing devices to align its image with the image of the other image capturing device. In addition to aligning the images, the parallax can be used, with known parameters of separation between the two lines of sight to perform range finding. The first image capturing device is preferably a CCD solid image capturing device of an interline transfer type. The second image capturing device is preferably a solid image capturing device of CMOS type. When preliminary measurement is performed, a part of the pixels of the second image capturing device are read out to determine such conditions as the focus of a photographic lens, the F-value of an aperture and the shutter speed.

### BACKGROUND OF THE INVENTION

The present invention relates to an image capturing apparatus having images capturing devices.

Various image capturing apparatuses with image capturing devices are conventionally used. Examples of such apparatuses include digital cameras for recording still images in the form of digital signals.

Referring to FIG. 3, a prior art digital cameral has a photographic lens 2 disposed on its optical axis in front of an aperture 3 and a shutter 4. A CCD-type solid image capturing device 5 receives an optical image formed by the elements before it. An analog processing circuit 6 receives the output of the solid image capturing device 5. A solid image capturing device driving circuit 7 controls the analog processing circuit 6 and the solid image capturing device 5. An analog-digital converter 8 digitizes the output of the analog processing circuit. The digital data from the analog to digital converter 8 is applied to an image processing circuit 9. The image processing circuit 9 is connected to a bus, to which an external recording means 12 is connected. The external recording means 12 includes a conventional recording medium such as, for example, card-type memory or a tape. A display device 15, having, for example, a liquid crystal panel and other necessary elements, is also connected to the image processing circuit 9 via a display control circuit 14. A CPU 16 is also connected to the bus to control the above components. A conventional operating means (not shown) equipped with a release button and a means to change the function of the digital camera between moving image recording (video) and still image recording is connected to the CPU 16.

Examples of applicable configurations include a first configuration using a CCD (charge-coupled device) solid image capturing device of an interline transfer type (hereinafter called the ITCCD-type solid image capturing device) as the solid image capturing device 5. A second configuration uses a CCD (charge-coupled device) solid image capturing device of a full-frame transfer type (hereinafter called the FFTCCD-type solid image capturing device) as the solid image capturing device 5. A third configuration uses a CCD (charge-coupled device) solid image capturing device of a frame transfer type (hereinafter called the FCCD-type solid image capturing device) as the solid image capturing device 5.

Referring now to FIG. 4, another example of a digital camera 1 is similar to the device of the fourth configuration of FIG. 3, except that the shutter of FIG. 3 is omitted.

Referring to FIG. 5, a fifth prior art configuration of a digital camera 1 uses an ITCCD-type solid image capturing device 5. This configuration is similar to FIG. 3 except for the addition of a finder lens 17, and a variable power zoom synchronizing mechanism 18. The zoom synchronizing mechanism 18 changes the field angle of the finder lens 17 in synch with changes in the zoomed field angle, also known as the degree of zoom, of the photographic lens 2 as the field of view of the photographic lens 2 is zoomed.

Next, the photographing function of each of the first through fifth configurations is explained hereunder.

Both the first and third configurations shown in FIG. 3 are capable of moving image recording and still image recording. In the case of moving image recording, the rays of light representing the image of the subject pass through the photographic lens 2. After the amount of light is adjusted by the aperture 3, the light passes through the shutter 4, which is kept open, and is focused on the light receiving surface of the solid image capturing device 5. The solid image capturing device 5 is driven by the solid image capturing device driving circuit 7. Normally, the number of the pixels in a solid image capturing device 5 greatly exceeds the standard number of pixels necessary for moving image recording. Therefore, when the solid image capturing device 5 is used for both moving image recording and high resolution still image recording, the solid image capturing device driving circuit 7 conducts omission read-out along the scan lines during moving image recording. Omission read-out is a method of read-out omits reading out of unnecessary data. The analog data of the image is output from the solid image capturing device 5 in the form of analog image signals. The analog signals are analog-processed by the analog processing circuit 6 and then converted to digital data by the analog-digital converter 8. The digital data is then input to the image processing circuit 9. The image processed by the image processing circuit 9 goes through the display control circuit 14 for display on the display device 15. In this embodiment, the display device 15 functions as a finder. If the user has chosen the moving image recording mode (movie mode) by a selecting means, the moving image is also recorded on the external recording means 12 simultaneously with display of the image on the display device 15. Furthermore, throughout the process of moving image recording, the CPU 16 monitors the focus and the brightness of the image obtained and controls the various components to constantly maintain the appropriate conditions of the focus of the photographic lens 2, the F-value of the aperture 3, and the solid image capturing device driving circuit 7 controlling the electronic shutter function of the solid image capturing device 5.

The flow of image signals during still image recording is basically the same as that of moving image recording; a moving image is obtained by omission read-out of the solid image capturing device 5, and the image thus obtained is displayed as a finder image on the display device 15. Meanwhile, the CPU 16 controls the focus of the photographic lens 2 and the F-value of the aperture 3. When the user pushes down the release button, the CPU 16 controls the light shielding function of the shutter 4 so that the shutter 4 and the F-value of the aperture 3 together produce an appropriate level of brightness. At the same time, the CPU 16 controls the solid image capturing device driving circuit 7 to stop the omission read-out of the solid image capturing device 5 and switch its operation mode to the full pixel read-out so that a desired high resolution still image is produced. In case the number of pixels to be read out is increased for the sake of the image quality of a still image, the read-out time required for a still image exceeds that of the standard set for 1 frame of moving images.

FIG. 3 also shows the second configuration, which uses an FFTCCD-type solid image capturing device. This configuration is not adapted to perform moving image recording. The process of still image recording using said FFTCCD-type solid image capturing device is now explained. When the user presses the release button or operates other similar functions, another means (not shown) that is provided separately from the aforementioned CPU 16 performs photometry and range finding. Thereafter, still image exposure is initiated, and the image data is processed in the same manner as in case of the first configuration or the third configuration.

According to the fourth configuration shown in FIG. 4, which uses an ITCCD-type solid image capturing device and is not provided with a shutter, moving image recording is performed by omission read-out of the solid image capturing device 5 to obtain a moving image. The image signals are processed in the same manner as in case of the first configuration.

When taking a still image, a moving image obtained by omission read-out of the solid image capturing device 5 is displayed on the display device 15 to perform range finding. The CPU 16 performs sequential control to ensure appropriate focusing of the photographic lens 2, F-value of the aperture 3, and functioning of the electronic shutter of the solid image capturing device 5. When the user presses the release button (not shown) or operates other similar functions, the function mode of the solid image capturing device 5 is changed over to the full pixel read-out mode so that a desired high resolution still image is obtained.

The functions of still image recording and moving image recording of the fifth configuration shown in FIG. 5 are the same as those of the first configuration. However, in addition to the finder function that calls for displaying a moving image obtained by omission read-out of the solid image capturing device 5 on the display device 15, the fifth configuration also enables the user to perform a framing function using the image of the subject viewed through a finder lens 17 when the solid image capturing device 5 and the display device 15 are stationary. The finder lens 17 is generally separate from the photographic lens 2. After the user has performed framing using the finder lens 17, the user presses the release button or operates other similar functions, and then, prior to actually taking a still image, activates the movie mode of the solid image capturing device 5 so that the CPU 16 decides and controls the focus of the photographic lens 2, the F-value of the aperture 3 and the shutter speed of the shutter 4 based on the moving image obtained from the solid image capturing device 5. At that point, the CPU 16 initiates exposure of the still image.

Because the photographic lens 2 and the finder lens 17 in the fifth configuration are separate optical systems, a variable power zoom synchronizing mechanism 18 is needed to synchronize the two optical systems as the view angle is changed during zooming. In other words, the variable power zoom synchronizing mechanism 18 is a mechanical device that synchronously changes the view angle of the photographic lens 2 and the view angle seen by the user through the finder lens 17 during zooming.

Regarding configurations that are capable of both still image recording and moving image recording, there are various requirements including:

(1) improving the quality of still images;

(2) improving the quality of moving images;

(3) reducing electric power consumption during moving image recording;

(4) reducing shutter-action lag when taking a still image;

(5) improving synchronicity of a moving image and the corresponding still image;

(6) selecting color filters;

(7) and solving problems regarding the finder optical system.

Concerning the problem of (1) improving the quality of still images, a miniature solid image capturing device is normally used in a digital camera of an inexpensive and commonly available type because of cost considerations. In case an ITCCD-type solid image capturing device mentioned in the explanation of the first configuration is used, however, the image field is not effectively used because of the structural reason that the image field has a light-shielding vertical transfer path. A vertical CCD does not contribute to accumulating image signals and is formed as a separate body from a light accumulating portion. It has been particularly difficult these past few years to improve the image quality, because the loss of the dynamic range and the decrease in the sensitivity have reached their limits. It is for this reason that a solid image capturing device of the ITCCD type cannot be regarded as the best among image capturing devices of many different types in respect to the image quality.

No shutter is provided in the fourth configuration. Therefore, in case there is a highly luminous portion in the frame during still image recording, it often produces a smear on the solid image capturing device, resulting in poor image quality.

The problem of (2) improving the quality of moving images is now discussed. For example, the third configuration using a solid image capturing device of the FTCCD type is capable of moving image recording. However, for the structural reason such that the transfer path does not have a light shielding portion, a solid image capturing device of the FTCCD type is far more prone to smears than is a solid image capturing device of the ITCCD type.

In case of the second configuration using a solid image capturing device of the FFTCCD type, the mechanical light shielding means must function at a high speed according to the frame rate, but it is difficult to achieve the TV-standard frame rate with this type of device. In other words, it is extremely difficult to obtain a moving image with the second configuration.

The problem of (3) reduction of electric power consumption during moving image recording is now discussed. In case a still image CCD having a large number of pixels is used for moving image recording, omission read-out is a normal, and indeed, a necessary procedure, in order to obtain the number of pixels corresponding to the TV standard and to achieve the frame rate appropriate for moving images. However, a CCD-type solid image capturing device is capable of omission read-out in the vertical direction but not in the horizontal direction. In other words, when performing horizontal read-out, even unnecessary pixels must be read out. While horizontal CCD drive consumes the largest share of electric power, a great amount of electric power is wasted by reading out unnecessary pixels.

Regarding (4) reduction of shutter-action lag when still image recording is performed, cost benefits can be expected by performing photometry and range finding by a solid image capturing device used for photographing as is true in case of the first or fourth configuration. In case an optical finder is separately provided and actively used like the fifth configuration, there is no need for constantly driving the image capturing device during the movie mode and this is therefore effective in reducing electric power consumption. When taking a still image, however, the user has to follow a procedure which includes pressing the release button, conducting photometry and range finding and then actually capturing an image. This required sequence results in a time lag between the moment when the user intends to take a picture and the moment of actual image capturing. Such a time lag often makes framing of a moving subject difficult, a crucial photographic chance to be missed, or causes other undesirable events.

Regarding (5) synchronicity of a moving image and the corresponding still image, each of the aforementioned configurations has only a single image capturing means. It is therefore difficult to obtain a high resolution still image having a large number of pixels while continuously taking a moving image that moves smoothly with a frame rate sufficiently high to satisfy the current TV standard. Continuous moving image recording is impossible particularly in case of the first configuration, where the apparatus includes a mechanical shutter which requires action of temporarily shielding the solid image capturing device in order to improve the quality of the still image.

The problem of (6) selection of color filters is discussed hereunder. When performing moving image recording or preliminary photometry, it is advantageous to use a complementary color filter having a high transmittance and sensitivity, because the exposure time for moving image recording is limited by the frame rate, and a short duration for preliminary photometry is desirable. If more importance is placed on reproduction of the colors of a still image, it is more advantageous to choose a primary color filter, which has a low sensitivity but better color separation. If the apparatus has only a single image capturing means, it is difficult to satisfy both conditions.

The problem of (7) solving problems regarding the finder optical system is discussed hereunder. In case a photographic optical system and a finder optical system are provided as separate systems as in the fifth configuration, precise framing is difficult due to parallax. Furthermore, a structure including a synchronizing mechanism adapted to change the zoom magnification of the photographing lens in synch with that of the finder lens not only increases production costs but also presents a problem in that, when the zoom magnification is increased, the dimensions of the synchronizing mechanism, too, are increased while the parallax becomes impracticably large.

Among various solid image capturing devices used in digital cameras or other such products, ITCCD-type solid image capturing devices, which are presently the mainstream, can be used both for moving image recording and still image recording. However, because they were originally developed for recording moving images, ITCCD-type solid image capturing devices have a structure that includes a light-shielding vertical transfer path, which makes no contribution to the accumulation of image signals and is therefore disadvantageous for maintaining high quality still images. This particular structure also presents such problems as a complicated production process which results in an increase in cost. Should the dimensions of the device be reduced in order to reduce the cost, the size of each pixel, too, is reduced. The presence of the light-shielding vertical transfer path makes it difficult to ensure sufficient dynamic range. The result is problems such as increased noise and reduced sensitivity. Therefore, ITCCD-type solid image capturing devices are by no means the most suitable devices for reconciling the quality of still images and production cost. Because the number of pixels of an ITCCD-type solid image capturing device is considerably greater than the number of pixels required by the present TV standard, omission read-out, which omits the read-out of unnecessary pixels, is most widely practiced. However, CCD-type solid image capturing devices present a problem in that they are prone to wasteful consumption of electric power for reading out unnecessary pixels, because they are not always economical in power consumption and also are incapable of horizontal omission read-out. As it is described above, successfully recording of both moving images and still images with an ITCCD-type solid image capturing device is only possible at the cost of image quality and power consumption, which are the two most important factors for a camera.

### OBJECTS AND SUMMARY OF THE INVENTION

In order to solve the above problem, an object of the present invention is to provide an image capturing apparatus which offers various improved characteristics, including better image quality.

An image capturing apparatus according to the invention includes a first image capturing device, a second image capturing device having characteristics different from those of the first image capturing device, a recording means for recording image data, and a processing means which is capable of processing data of images captured by the first image capturing device and data of images captured by the second image capturing device in such a manner that the two types of images are treated as individual images that are independent of each other.

With the configuration as above, various characteristics of the image capturing apparatus can easily be improved by providing a plurality of image capturing means that have different characteristics and, by using a processing means, processing images taken by the image capturing means as individual images independent of one another. The various characteristics of the image capturing apparatus can easily be improved by the configuration wherein the first image capturing means and the second image capturing means may both capture either still images or moving images, or one of the image capturing means may capture a still image while the other image capturing means takes a moving image.

An image capturing apparatus according to the invention includes a first image capturing device, a second image capturing device having characteristics different from those of the first image capturing device, a recording means for recording image data, and a processing means which is capable of processing data of images captured by the first image capturing device as still images and data of images captured by the second image capturing device as still images or moving images.

Because a plurality of image capturing means having different characteristics are provided, the configuration described above enables the easy improvement of the various characteristics by designing the image capturing means such that one of them has characteristics suitable for still image recording and that another image capturing means has characteristics suitable for both still image recording and moving image recording.

An image capturing apparatus according to the invention includes a first image capturing device, a second image capturing device having characteristics different from those of the first image capturing device, a recording means for recording image data, and a processing means which is capable of processing data of images captured by the first image capturing device as still images and data of images captured by the second image capturing device as moving images.

Because a plurality of image capturing means having different characteristics are provided, the configuration described above enables the easy improvement of the various characteristics by designing the image capturing means such that one of them has characteristics suitable for still image recording and another image capturing means has characteristics suitable for recording moving images.

An image capturing apparatus according to the invention is an image capturing apparatus as described above, wherein the first image capturing device is used for still image recording, and the second image capturing device is used for capturing moving images and similar purposes, including preliminary measurement for still image recording.

The configuration described above enables the easy improvement of the various characteristics by designing one of the image capturing means to have characteristics suitable for still image recording and another image capturing means to have characteristics suitable for moving image recording. Furthermore, by using the second image capturing means, which is suitable for moving image recording, for preliminary measurement intended for still image recording, the time lag that occurs when a still image is taken is reduced.

An image capturing apparatus according to the invention is an image capturing apparatus as described above, wherein the image capturing apparatus includes at least one optical system for directing the light representing an image of the subject to the first and the second image capturing means, a recording means which is capable of recording data of images captured by the first image capturing means as still images and also capable of recording data of images captured by the second image capturing means as moving images, and a display means for displaying image data.

According to the configuration described above, an image capturing apparatus which is capable of capturing and recording both still images and moving images can be provided.

An image capturing apparatus according to the invention is an image capturing apparatus as described above, wherein the first image capturing means is provided with a CCD solid image capturing device of the full-frame transfer type.

By using a solid image capturing device which has features such as a simple internal structure, a photosensitive surface whose entire area serves as a signal accumulator, having a wide opening and enabling high dynamic range, high sensitivity and low noise, the configuration described above is capable of providing still images of high quality at low cost.

An image capturing apparatus according to the invention is an image capturing apparatus as described above, wherein the second image capturing means is provided with a CMOS-type solid image capturing device.

By using a CMOS-type solid image capturing device, which has features such that it can be produced by a simple process and that its peripheral circuits are very easy to form, the configuration described above is capable of capturing stable moving images at low cost. Regarding electric power consumption during moving image recording, power consumption increases when an image capturing device is continuously driven, for example during the taking of a moving image or the performance of various preliminary measurement conducted prior to actual recording of a still image in order to find conditions of the subject. Such an increase in power consumption is reduced considerably by using a CMOS-type solid image capturing device. Concerning omission read-out of pixels, the embodiment enables the selective read-out so that it is possible to read only the necessary portion two-dimensionally from the entire image field, thereby further reducing power consumption.

An image capturing apparatus according to the invention is an image capturing apparatus as described above, wherein the image capturing apparatus is provided with an optical system adapted to divide the rays of light representing an image of the subject and respectively direct the divided rays of light to the first and the second image capturing means.

The configuration described above is free from the problem of parallax because both fields of view rely on the same optical axis. Thus parallax is prevented even if the image capturing apparatus uses a plurality of image capturing devices. The configuration also simplifies the structure and reduces production costs.

An image capturing apparatus according to the invention is an image capturing apparatus as described above, wherein the image capturing apparatus includes a first optical system and a second optical system that respectively correspond to the first image capturing means and the second image capturing means, and the processing means is adapted to correct the difference in image capturing position between the first optical system and the second optical system.

By using optical systems provided independently of each other in an image capturing apparatus that includes a plurality of image capturing devices, the configuration described above enables the provision of optical systems that are suitable for the respective image capturing devices, and, as a result, is capable of improving the image quality or reducing production costs by simplifying the structure. Furthermore, by processing the parallax between the optical systems by using a processing means, it is also possible to eliminate the parallax while limiting the increase in costs.

### BRIEF DESCRIPTION OF THE DRAWINGS

FIG. 1 is a schematic illustration of an image capturing apparatus according to an embodiment of the present invention.

FIG. 2 is a schematic illustration of an image capturing apparatus according to another embodiment of the present invention.

FIG. 3 is a schematic illustration of a comparison example of an image capturing apparatus according to the prior art.

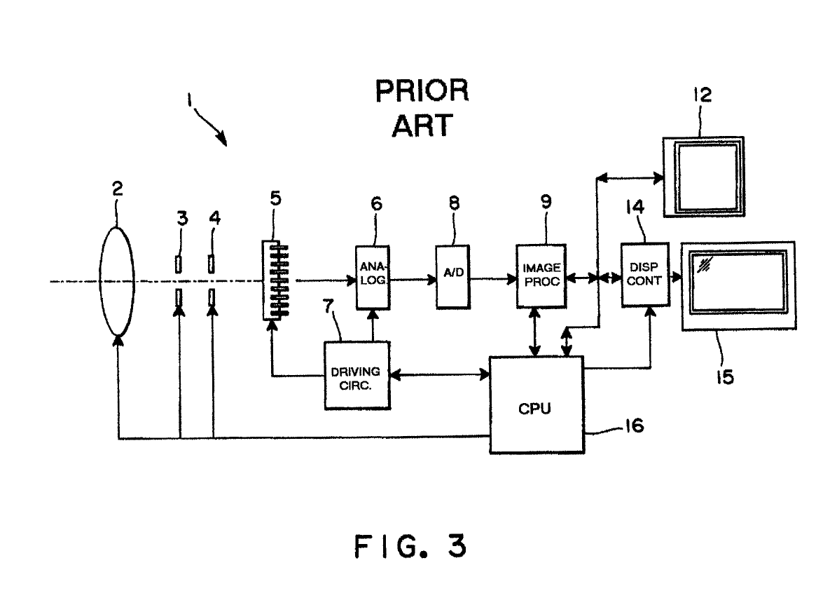

FIG. 4 is a schematic illustration of another comparison example of an image capturing apparatus according to the prior art.

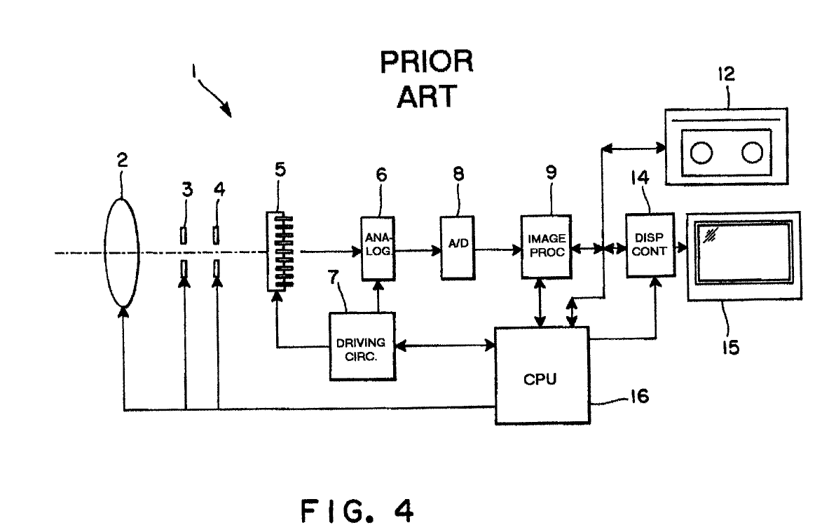

FIG. 5 is a schematic illustration of yet another comparison example of an image capturing apparatus according to the prior art.

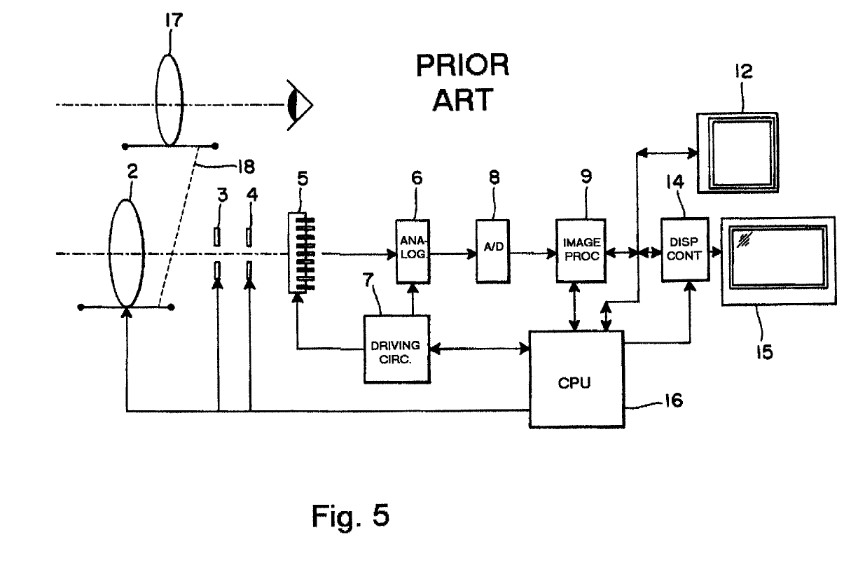

### DETAILED DESCRIPTION OF THE INVENTION

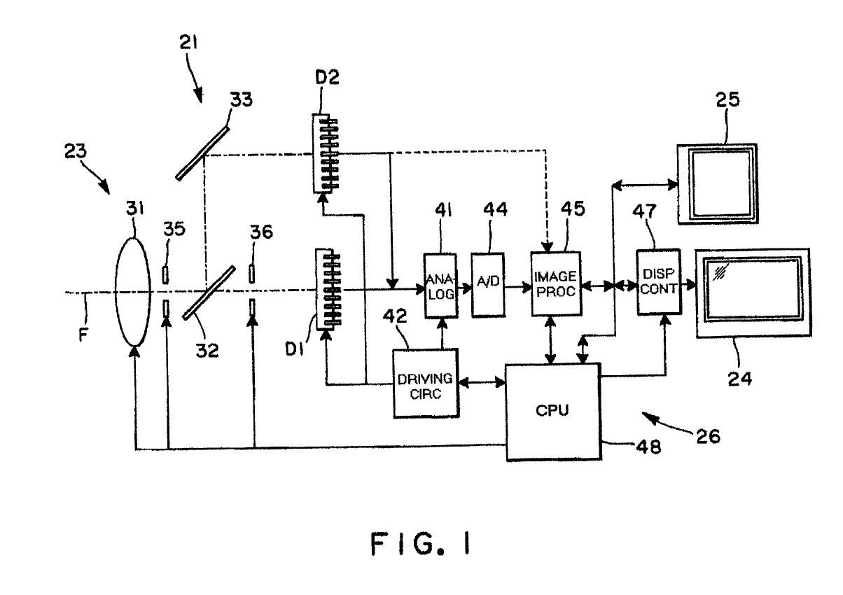

Referring to FIG. 1, an image capturing apparatus 21, which is generally called a digital camera for recording still images as digital signals and is also capable of recording moving images. The image capturing apparatus 21 is provided with a first image capturing device D1 and a second image capturing device D2. The image capturing devices D1 and D2 serve as first and second image capturing means, respectively. An optical system 23 directs light F, represented by a dot-dash line, representing the subject image (hereinafter referred to as the subject image light F), to the image capturing devices D1 and D2. A display means 24 displays images. A recording means 25 records image data. A processing means 26 controls the various components, including the image capturing devices D1 and D2, and processes image data.

The first image capturing device D1 is dedicated to still image recording. First image capturing device D1 uses a device that is especially suitable for still image recording. In the preferred embodiment, a CCD solid image capturing device of a full frame transfer type (hereinafter called FFTCCD-type solid image capturing device) is used.

The second image capturing device D2 is dedicated to moving image recording or such other purposes as preliminary operation for still image recording. Second image capturing device D2 preferably using a device especially suitable for motion images. In the present invention, a CMOS-type solid image capturing device is preferably used. Regarding such other characteristics as the dimensions of the device and the number of pixels, the two image capturing devices are chosen to be suitable respectively for moving image recording and still image recording. The number of pixels of the first image capturing device D1 is greater than the number of pixels of the second image capturing device D2.

The optical system 23 includes a photographic lens 31 disposed ahead of a shutter 35. Light passing through the aperture 35 impinges on a half-reflective mirror 32. Part of the light is reflected at 90 degrees from the surface of the half-reflective mirror 32 onto a total reflection mirror 33. The total reflection mirror 33 redirects the light onto the surface of the second image capturing device D2. The remaining part of the light impinging on the part reflective mirror 32 passes therethrough, and then through an aperture 36 on its path to the first image capturing device D1. Generally the part reflective mirror 32 splits the light into roughly equal parts, with one part reflected, and the other part transmitted. The photographic lens 31 includes conventional zoom and focusing mechanisms. Since such mechanisms are conventional, further description and illustration thereof is omitted. The aperture 35 is located on the side of the half reflective mirror 32 nearer the subject, i.e., on the side nearer the photographic lens 31. The mechanical shutter 36 is located on the side of the half reflective mirror 32 nearer toward the first image capturing device D1.

The display means 24 is any convenient display device which may include, for example, a liquid crystal panel and other necessary elements.

The recording means 25 is a recorder unit for recording or reading digital image data into or out of a medium which is a given external recording means. Examples of usable media include RAM which is an external memory module in the shape of a card or a stick, cassettes of magnetic tapes or the like, and various disks such as magnetic disks. Although a single recording means 25 may be sufficient, some applications of the image capturing apparatus may employ a plurality of recording means. For example, one recording means may be dedicated to recording still images, while a second recording means may be dedicated to recording moving images.

The processing means 26 includes an analog processing circuit 41 receiving data from the first and the second image capturing devices D1 and D2. An image capturing device driving circuit 42 controls the image capturing devices D1 and D2 and the analog processing circuit 41. The processing means 26 also contains an analog-to-digital converter 44 which digitizes the image date from the analog processing circuit 41 and applies the digitized result to an image processing circuit 45. The image processing circuit 45 is connected to a bus, to which the recording means 25. The bus is also connected to a display control circuit 47 which feeds display signals to the display means 24.

A CPU 48 is also connected to the bus. The CPU 48 constitutes the processing means 26. The CPU 48 produces control signals for mechanical control of various mechanical elements, including the aperture 35, the shutter 36, and the zoom and focusing mechanisms of the photographic lens 31. The CPU 48 produces control signals for controlling other components, such as the image capturing devices D1 and D2, the analog processing circuit 41, the image capturing device driving circuit 42, the analog-to-digital converter 44, the image processing circuit 45 and the display control circuit 47. In addition, the CPU perform evaluation and processing of images, as well as other necessary processing.

The image capturing apparatus 21 includes other conventional components (not shown in the drawings), including an operating means, a power supply unit, a microphone and a flash unit. The operating means has a release button and a selecting means, etc. The selecting means, e.g., a switch, switches the operation mode between moving image recording and still image recording.

Next, the function of the image capturing apparatus 21 is explained hereunder.

The amount of subject image light F passing through the photographic lens 31 is adjusted by opening or closing the aperture 35. Thereafter, the part of the light F that passes through the half reflective mirror 32 is focused on the image capturing surface of the first image capturing device D1 dedicated to still image recording. The exposure time for still image recording is controlled by the shutter 36. The part of the light that has passed through the aperture 35 and is reflected off the half reflective mirror 32, and is again reflected off the total reflection mirror 33 onto the second image capturing device D2 dedicated to moving image recording and preliminary measurement. It will be noted that there is no shutter in the optical path to the second image capturing device D2.

The image capturing devices D1 and D2 are driven by the image capturing device driving circuit 42. Signals output from the image capturing devices D1 and D2 are converted into digital signals in the analog processing circuit 41 and the analog-to-digital converter 44. The resulting digital signals are input to the image processing circuit 45. In some applications, it may be desirable for each of the image capturing devices D1 and D2 to have its own analog processing circuit and analog-to-digital converter. If the second image capturing device D2 includes its own analog processing circuit and an analog-to-digital converter, digital image signals output from the second image capturing device D2 are input directly into the image processing circuit 45. The signal path in this instance is shown as a dashed line which bypasses the analog processing circuit 41 and the analog-to-digital converter 44 which, in that event, are dedicated to processing data only from the first image capturing apparatus D1.

When performing moving image recording, image signals from the second image capturing device D2 undergo necessary processing by the image processing circuit 45. The display control circuit 47 displays the resulting images on the display means 24 in real time. Real-time display permits use of the display means 24 as a view finder to enable precise framing. When the user operates the selecting means to choose the movie mode, the CPU 48 connects moving image data output from the image processing circuit 45 to the external memory module attached to the recording means 25.

When performing still image recording, image signals from the second image capturing device D2 undergo necessary processing by the image processing circuit 45. The images are displayed on the display means 24 in real time by the display control circuit 47 so they can be used as a view finder to enable precise framing. When the CPU 48 detects that the release button has been pushed, the CPU 48 performs preliminary measurement prior to actual photographing. That is, the CPU 48 ascertains and processes a full frame image or a partial frame image from the second image capturing device D2 obtained by controlling the image capturing device driving circuit 42 so as to make preliminary determinations of various criteria, such as the focus of the photographic lens 31, the F-value of the aperture 35 and the shutter speed of the shutter 36. Thereafter, while controlling the photographic lens 31, the aperture 35, the shutter 36, etc. according to the determined criteria, the CPU 48 actuates the first image capturing device D1 to initiate and finish exposure. The still image data output from the first image capturing device D1 are processed by the analog processing circuit 41 and then converted into digital data by the analog-to-digital converter 44. The thus-obtained digital data undergoes digital image processing in the image processing circuit 45 and, finally, is saved in the external memory module of the recording means 25.

Other than using a full frame image of the second image capturing device D2 as described above, preliminary measurement for still image recording may also be performed by controlling the image capturing device driving circuit 42 in such a manner as to read only the portion that is absolutely necessary for the preliminary measurement from the second image capturing device D2. Such a partial read-out, which calls for reading solely the portion that is absolutely necessary for the preliminary measurement from the second image capturing device D2, reduces the time required for preliminary measurement, and consequently enables so-called high speed preliminary measurement. Therefore, partial read-out not only shortens shutter-action lag when still image recording is performed but also limits excessive power consumption, thereby increasing the life span of the battery.

In order to reconcile the aforementioned two functions, i.e., high speed preliminary measurement using partial read-out and the function as a finder with smooth moving images using full-frame images, the speed at which images are read out from the second image capturing device D2 may be increased (for example, a double or a four-fold increase) throughout the period when moving image frames for the finder function overlap an action of high speed preliminary measurement so that a plurality of frames for high speed preliminary measurement and moving image frames to be displayed coexist in the period of one TV-standard frame. This increases the read-out and results in reduction of output signals corresponding to the amount of decrease in storage time of moving image frames. The amount of such a reduction of output signals, however, can be compensated for by the amplifier gain of the analog processing circuit 41.

Examples of other configurations include one that performs preliminary measurement for still image recording by following a procedure comprising steps in which the second image capturing device D2 is driven while the first image capturing device D1 is at a standstill. Based on thus obtained moving images, the CPU 48 constantly repeats criteria determination for preliminary measurement, which is performed prior to actual photographing of a still image. The result of judgement is used for adjusting the focus of the photographic lens 31, the F-value of the aperture 35 or the like constantly or at the moment the user pushes down the release button. Finally, the CPU 48 actuates the first image capturing device D1 to perform exposure of a still image while controlling the shutter speed of the shutter 36. This configuration is capable of reducing the time lag from the point of operation by the user to the point of exposure, thereby considerably improving the problem of shutter-action lag.

Photographic recording of a still image may be conducted during moving image recording. When the CPU 48 detects that the release button has been pushed down during recording operation, the CPU 48 immediately initiates control of still image recording, so that after image data of both moving images and still images are processed by the image processing circuit 45. Thereafter, the data from both image capturing devices are recorded in the external memory module. Even if the amount of the simultaneously obtained data of the moving images and the still images stresses the processing capacity of the image processing circuit 45, a smooth moving image, free from so-called dropping frames or other problems, and high resolution still images can be simultaneously obtained by providing a separate memory (not shown) or other appropriate means for interim saving or buffering of data, and giving a lower priority to the processing of data of still images. For example, still-image data may be temporarily saved in the separate memory, from which it is retrieved and processed when the system is in a non-active period of moving image processing. This ensures that a required rate of data processing is available to satisfy TV standards or for other reasons.

As described above, the embodiment of the present invention relates to an image capturing apparatus, such as what is generally called a digital camera, and simultaneously includes a plurality of image capturing means which are selectively used in such a manner that one is used for still image recording while another is dedicated to capturing moving images and similar purposes including preliminary operation for still image recording. An image capturing device suitable for still image recording, e.g., an FFTCCD-type solid image capturing device, is used as the first image capturing device D1 for still image recording, and an image capturing device suitable for moving images, e.g., a CMOS-type solid image capturing device, is used as the second image capturing device D2 for capturing moving images and similar purposes including preliminary operation for still image recording. As a result of these features, the embodiment described above achieves still images of high quality, moving images of good quality having less defects, such as smears, and superb release reaction at the time of still image recording while limiting power consumption. In other words, the embodiment ensures superior image quality for both moving images and still images with the same camera.

To be more specific, concerning (1) the quality of still images, a picture having such a high quality as to be difficult to obtain with an ITCCD-type solid image capturing device or the like can be produced at low cost by using, for example, an FFTCCD-type solid image capturing device, which has such features as the simplest internal structure, a photosensitive surface whose entire area serves as a signal accumulator, and a wide opening, as well as a high dynamic range, a high sensitivity and low noise.

Regarding (2) the quality of moving images, stable moving images are produced at low cost by using, for example, a CMOS-type solid image capturing device which has features such that it can be produced by a simple process and that its peripheral circuits, too, are easy to form.

Regarding (3) electric power consumption during moving image recording, power consumption increases when an image capturing device is continuously driven, for example at the time of taking a moving image or various preliminary measurement conducted prior to actual recording of a still image in order to find conditions of the subject. Such an increase in power consumption can be reduced considerably by using a CMOS-type solid image capturing device. Concerning omission read-out of pixels, too, the embodiment enables the selective read-out so that it is possible to read only the necessary portion two-dimensionally from the entire image field, thereby improving the power consumption even more effectively.

The problem concerning (4) shutter-action lag that occurs when a still image is taken is now considered. Regarding preliminary measurement performed prior to actual photographing of a still image, partial selective read-out from the image field becomes possible by using, for example, a CMOS-type solid image capturing device described above. Because there is no need for read-out of pixels that are not necessary for the measurement, high speed preliminary measurement becomes possible, and the time lag from the moment when the release button is pressed to the moment of actual photographing of a still image is shortened significantly. Furthermore, by constantly driving an image capturing device for capturing moving images and similar purposes, e.g., a CMOS-type solid image capturing device, for the purpose of preliminary measurement so that the image capturing device is maintained in the state where it is ready for still image recording, the shutter-action lag is virtually eliminated without greatly increasing power consumption.

Regarding (5) synchronicity of a moving image and the corresponding still image, providing a plurality of image capturing means, for example two image capturing means, easily makes it possible to take a high resolution still photograph having a great number of pixels while continuously shooting a smooth motion picture that correspond to the current TV standards requiring a high frame rate.

Regarding (6) selection of color filters, the embodiment enables the selection of color filters of different types depending on whether the color filter is used in an image capturing means dedicated to capturing moving images and similar purposes or an image capturing means dedicated to still image recording. Therefore, a complementary color filter may be selected for an image capturing means dedicated to capturing moving images and similar purposes so as to take full advantage of its high sensitivity, thereby improving the ability of the image capturing means to take a moving image having a low luminosity and achieving accurate and high speed preliminary measurement, while a primary color filter may be selected for an image capturing means used for still image recording, thereby achieving a superior ability in reproduction of colors.

Regarding (7) the finder optical system, parallax or other similar problems are prevented by using a half reflective mirror or the like to permit a single optical system to be used for both moving images and still images.

As described above, by using an image capturing device most appropriate for still image recording, such as an FFTCCD-type solid image capturing device, for still image recording to obtain superior image quality, and using an image capturing device most appropriate for moving images, such as an FFTCCD-type solid image capturing device, for recording moving images, the embodiment described above is capable of obtaining superior image quality while limiting power consumption without greatly increasing production costs. Because the aforementioned FFTCCD-type solid image capturing device includes no light-shielding vertical transfer path and is easy to produce at low cost, while having such superior characteristics as a high dynamic range, low noise and high sensitivity. A CMOS-type solid image capturing device is less efficient than an FFTCCD-type solid image capturing device in making use of the photosensitive field but has such favorable characteristics as an inexpensive production process, the ability of selective read-out of pixels, low power consumption and simple peripheral circuits. Furthermore, because a plurality of image capturing means are present, the embodiment is also effective in making a significant improvement in shutter-action lag that occurs when a still image is taken, simultaneous photographing a moving image and a high resolution still image, and improving the sensitivity of the device when performing preliminary measurement.

Although a single optical system is used for both moving images and still images by using a half reflective mirror or the like according to the embodiment shown in FIG. 1, the invention may be provided with a plurality of optical systems that respectively include photographing lenses, which are independent of one another.

Examples of such configurations include an apparatus having a plurality of units, each of which consists of a combination of an optical system and an image capturing means, such as a solid image capturing device. At least one unit of an optical system and an image capturing means serves as the reference unit. The parallax and the difference in the view angle, which is caused by zooming, between the reference unit and each one of the other units can be compensated and eliminated by the read-out function and image processing of the image capturing means, e.g., CMOS-type solid image capturing devices.

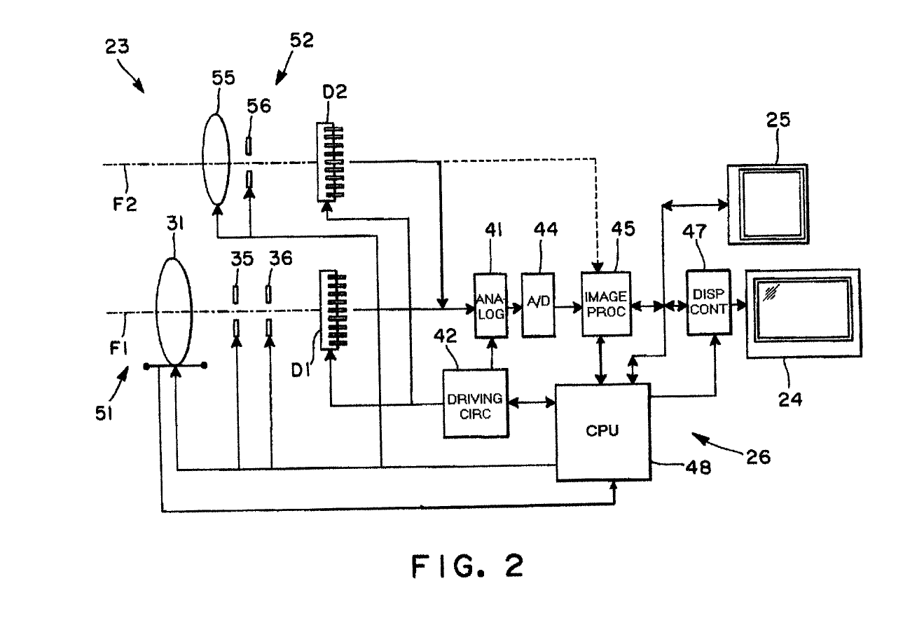

For example, as shown in FIG. 2, the optical system 23 may be comprised of a first optical system 51 combined with the first image capturing device D1 and a second optical system 52 combined with the second image capturing device D2. The first optical system 51 has a photographic lens 31, which is a zoom lens, an aperture 35 and a mechanical shutter 36. The second optical system 52 has a photographing lens 55, which is a fixed-focus lens, and an aperture 56. The photographing lenses 31, 55, the apertures 35, 55 and the shutter 36 are controlled by a CPU 48. The conditions of the first optical system 51, including the focus and the zoom magnification of the photographic lens 31, are input to the CPU 48.

According to the configuration shown in FIG. 2, the amount of the subject image light F1 that has passed through the photographic lens 31 of the first optical system 51 is adjusted by the aperture 35. The exposure time is adjusted by the shutter 36. The light F1 is also focused on the image capturing surface of the first image capturing device D1, which is the solid image capturing device dedicated to still image recording. Meanwhile, the amount of the subject image light F2 that has passed through the photographing lens 55 of the second optical system 52 is adjusted by the aperture 56. The light F2 is then focused on the image capturing surface of the second image capturing device D2, which is the solid image capturing device dedicated to moving image recording. The image capturing devices D1 and D2 and their driving method and the flow of image signal are the same as those of the embodiment shown in FIG. 1.

When a moving image is taken, the photographing lens 55 and the aperture 56 of the second optical system 52 and the second image capturing device D2 are used. The moving image signals output from the second image capturing device D2 are displayed on a display means 24 so that they can also be used for the finder function. Throughout the period of moving image recording, the CPU 48 constantly controls the focus of the photographing lens 55, the F-value of the aperture 56 and an electronic shutter of the second image capturing device D2 by determining and processing the data based on images obtained as moving images so that these components are maintained in appropriate conditions.

In case a still photograph is taken while the apparatus is in the movie mode, the degree of the parallax can be found from the distance to the primary subject, which distance is calculated based on the condition of the focus of the photographing lens 55 currently set by the CPU 48, and the mechanical displacement between the photographing lens 55 for moving image recording and the photographic lens 31 for still images. The CPU 48 performs these calculations and controls the image capturing device driving circuit 42 to shift the image field read out from the second image capturing device D2 by the distance corresponding to the degree of parallax, thereby automatically correcting for parallax between the photographing lenses 31, 55.

The CPU 48 also monitors the zoom magnification of the photographic lens 31 and controls the image capturing device driving circuit 42 so that when the view angle changes as a result of a change in the magnification, the image field of the second image capturing device D2 is read out in the scale corresponding to the changed view angle.

Thus, the image of a desired size read out from the second image capturing device D2 is corrected to an appropriate size by the image processing circuit 45 and displayed or recorded as a moving image.

Regarding (7) the finder optical system, in case the moving image optical system and the still image optical system are separate systems, a parallax is generated between the two optical systems as a logical consequence. According to the configuration described above, however, using a CMOS-type solid image capturing device or the like as the solid image capturing device used for moving image enables partial selective read-out, which calls for extracting and reading out a desired portion of the image field. Then, if the distance to the subject is already known, the parallax, which can be calculated from the displacement between the two optical systems, can easily be corrected. Furthermore, as an application of this process of parallax correction, a change in the view angle caused by zooming is also corrected by combining this process with image processing. Therefore, the highly flexible read-out process of a CMOS-type image capturing device may be combined with image processing, with an expensive zoom lens used only for still images, of which image quality is usually given the priority, and a single focus lens used as the photographic lens dedicated to moving images, including its use for the finder function. The embodiment described above is thus capable of providing an inexpensive image capturing apparatus, which is equipped with a zoom lens without the need of a variable power zoom synchronizing mechanism or a similar means.

The structure including photographing lenses that are respectively provided for still image recording and moving image recording enables the calculation of the distance to the subject by using the parallax between the two optical systems. After the subject which is selected by the user by means of a switch or the like from among finder images displayed in real time as a moving image on the display means is recognized as a pattern, still images of the subject are simultaneously captured by the photographing lens of the first optical system and the first image capturing device, which are dedicated to still image recording, and the photographing lens of the second optical system and the second image capturing device dedicated to moving image recording. From the two still images thus obtained, the parallax is calculated by detecting patterns of the selected subject. The accurate distance to the subject can be calculated from the parallax and various mechanical factors of the two optical systems, such as the base lengths and the focal lengths.

The usage of the aforementioned ability of the embodiment to calculate the distance to the subject that has been recognized as a pattern is not limited to automatic focusing (intelligent AF). For example, the calculated distance to the subject may be displayed or recorded together with the obtained image. Furthermore, by including such a range finding function, an apparatus according to the invention not only serves as a photographic camera but may also be effectively applied to business-level use, including a golf course and other leisure facilities which have a demand for the range finding function of the embodiment, as well as use at construction and civil engineering sites, and for recording the site of an accident, etc.

According to the configuration of the image capturing apparatus according to the invention, various characteristics of the image capturing apparatus can easily be improved by providing a plurality of image capturing means that have different characteristics and, by using a processing means, processing images taken by the image capturing means as individual images independent of one another. The various characteristics of the image capturing apparatus can easily be improved by the configuration wherein the first image capturing means and the second image capturing means may both capture either still images or moving images, or one of the image capturing means may capture a still image while the other image capturing means takes a moving image.

Because the invention includes a plurality of image capturing means having different characteristics, the image capturing apparatus according to the invention enables the easy improvement of the various characteristics by designing the image capturing means such that one of them has characteristics suitable for still image recording and that another image capturing means is capable of both still image recording and moving image recording.

Because a plurality of image capturing means having different characteristics are provided, the image capturing apparatus according to the invention enables the easy improvement of the various characteristics by designing the image capturing means such that one of them has characteristics suitable for still image recording and that another image capturing means has characteristics suitable for recording moving images.

While having the same effect as that of an image capturing apparatus in the foregoing paragraphs, the image capturing apparatus according to the invention enables the easy improvement of the various characteristics by designing one of the image capturing means to have characteristics suitable for still image recording and another image capturing means to have characteristics suitable for moving image recording. Furthermore, by using the second image capturing means, which is suitable for moving image recording, for preliminary measurement intended for still image recording, the time lag that occurs when a still image is taken can be reduced.

An image capturing apparatus according to the invention includes at least one optical system for directing the light representing an image of the subject to the first and the second image capturing means, a recording means which is capable of recording data of images captured by the first image capturing means as still images and also capable of recording data of images captured by the second image capturing means as moving images, and a display means for displaying image data. Therefore, while having the same effect as that of an image capturing apparatus in the foregoing paragraphs, the image capturing apparatus according to the invention provides an image capturing apparatus which is capable of capturing and recording both still images and moving images.

While having the same effect as that of an image capturing apparatus described in the foregoing paragraphs, the image capturing apparatus according to the invention is capable of providing still images of a high quality at low cost by using as the first image capturing means a CCD solid image capturing device of the full-frame transfer type, which has features such as a simple internal structure, a photosensitive surface whose entire area serves as a signal accumulator, having a wide opening and enabling the high dynamic range, high sensitivity and low noises.

While having the same effect as that of an image capturing apparatus described in the foregoing paragraphs, the image capturing apparatus according to the invention is capable of producing stable moving images at low cost by using as the second image capturing means a CMOS-type solid image capturing device, which has features such that it can be produced by a simple process and that its peripheral circuits, too, are very easy to form. Regarding electric power consumption during moving image recording, power consumption increases when an image capturing device is continuously driven, for example at the time of taking a moving image or various preliminary measurement conducted prior to actual recording of a still image in order to find conditions of the subject. Such an increase in power consumption can be reduced to a considerably low extent by using a CMOS-type solid image capturing device. Concerning omission read-out of pixels, too, the embodiment enables the selective read-out so that it is possible to read only the necessary portion two-dimensionally from the entire image field, thereby improving the power consumption even more effectively.

An image capturing apparatus according to the invention has an optical system adapted to divide the same light representing an image of the subject and respectively direct the divided rays of light to the first and the second image capturing means. Therefore, while having the same effect as that of an image capturing apparatus described in the foregoing paragraphs, the image capturing apparatus according to the invention is capable of simplifying the configuration and reducing production costs without causing a problem of parallax, even if the image capturing apparatus includes a plurality of image capturing devices.

An image capturing apparatus according to the invention is an image capturing apparatus having a plurality of image capturing devices, wherein the apparatus includes optical systems that are provided independently of each other. Therefore, while having the same effect as that of an image capturing apparatus described in the foregoing paragraphs, the image capturing apparatus according to the invention enables the provision of optical systems that are respectively suitable for the image capturing devices, and, as a result, is capable of improving the image quality or reducing production costs by simplifying the structure. Furthermore, by processing the parallax between the optical systems by using a processing means, it is also possible to eliminate the parallax while limiting the increase in costs.

Having described preferred embodiments of the invention with reference to the accompanying drawings, it is to be understood that the invention is not limited to those precise embodiments, and that various changes and modifications may be effected therein by one skilled in the art without departing from the scope or spirit of the invention as defined in the appended claims.

What is claimed is:

1. An image capturing apparatus including:
a first image capturing device;
said first image capturing device having a first characteristic;
a second image capturing device;
said second image capturing device having a second characteristic;
said first and second characteristics being different;
a recording means for recording image data; and
a processing means for processing data of images captured by said first image capturing device and data of images captured by said second image capturing device in such a manner that the two types of images are treated as individual images that are independent of each other.

2. An image capturing apparatus including:
a first image capturing device;
a second image capturing device having characteristics different from those of said first image capturing device;
a recording means for recording image data; and
a processing means for processing data of images captured by said first image capturing device as still images and data of images captured by said second image capturing device as still images or moving images.

3. An image capturing apparatus including:
a first image capturing device;
a second image capturing device having characteristics different from those of said first image capturing device;
a recording means for recording image data; and
a processing means for processing data of images captured by said first image capturing device as still images and data of images captured by said second image capturing device as moving images.

4. An image capturing apparatus as claimed in claim 1, wherein:
said first image capturing device is used for still image recording, and
said second image capturing device is used for capturing moving images;
said second image capturing device also providing preliminary measurement for use in still image recording.

5. An image capturing apparatus as claimed in claim 2, wherein:
said first image capturing device is used for still image recording, and
said second image capturing device is used for capturing moving images;
said second image capturing device also providing preliminary measurement for use in still image recording.

6. An image capturing apparatus as claimed in claim 3, wherein:
said first image capturing device is used for still image recording, and
said second image capturing device is used for capturing moving images;
said second image capturing device also providing preliminary measurement for use in still image recording.

7. An image capturing apparatus as claimed in claim 1, further comprising:
at least one optical system for directing light representing an image of a subject to said first and said second image capturing means;
a recording means for recording data of images captured by said first image capturing means as still images and for recording data of images captured by said second image capturing means as moving images; and
a display means for displaying image data.

8. An image capturing apparatus as claimed in claim 2, further comprising:
at least one optical system for directing light representing an image of a subject to said first and said second image capturing means;
a recording means for recording data of images captured by said first image capturing means as still images and for recording data of images captured by said second image capturing means as moving images; and
a display means for displaying image data.

9. An image capturing apparatus as claimed in claim 3, further comprising:
at least one optical system for directing light representing an image of a subject to said first and said second image capturing means;
a recording means for recording data of images captured by said first image capturing means as still images and for recording data of images captured by said second image capturing means as moving images; and
a display means for displaying image data.

10. An image capturing apparatus as claimed in claim 4, further comprising:
at least one optical system for directing light representing an image of a subject to said first and said second image capturing means;
a recording means for recording data of images captured by said first image capturing means as still images and for recording data of images captured by said second image capturing means as moving images; and
a display means for displaying image data.

11. An image capturing apparatus as claimed in claim 5, further comprising:
at least one optical system for directing light representing an image of a subject to said first and second image capturing means;
a recording means for recording data of images captured by said first image capturing means as still images and for recording data of images captured by said second image capturing means as moving images; and
a display means for displaying image data.

12. An image capturing apparatus as claimed in claim 6, further comprising:
at least one optical system for directing light representing an image of a subject to said first and second image capturing means;
a recording means for recording data of images captured by said first image capturing means as still images and for recording data of images captured by said second image capturing means as moving images; and
a display means for displaying image data.

13. An image capturing apparatus as claimed in claim 1, wherein said first image capturing means is a CCD solid image capturing device of the full-frame transfer type.

14. An image capturing apparatus as claimed in claim 2, wherein said first image capturing means is a CCD solid image capturing device of the full-frame transfer type.

15. An image capturing apparatus as claimed in claim 3, wherein said first image capturing means is a CCD solid image capturing device of the full-frame transfer type.

16. An image capturing apparatus as claimed in claim 1, wherein said second image capturing means includes a CMOS-type solid image capturing device.

17. An image capturing apparatus as claimed in claim 2, wherein said second image capturing means includes CMOS-type solid image capturing device.

18. An image capturing apparatus as claimed in claim 3, wherein said second image capturing means includes a CMOS-type solid image capturing device.

19. An image capturing apparatus as claimed in claim 1, wherein:
said image capturing apparatus includes an optical system; and
said optical system includes means for dividing light representing an image of a subject and respectively directing the divided rays of light to said first and said second image capturing means.

20. An image capturing apparatus as claimed in claim 2, wherein:
said image capturing apparatus includes an optical system; and
said optical system includes means for dividing light representing an image of a subject and respectively directing the divided rays of light to said first and said second image capturing means.

21. An image capturing apparatus as claimed in claim 3, wherein:
said image capturing apparatus includes an optical system; and
said optical system including means for dividing light representing an image of a subject and respectively directing the divided rays of light to said first and said second image capturing means.

22. An image capturing apparatus as claimed in claim 1, wherein:
said image capturing apparatus includes a first optical system and a second optical system;
said first optical system supplying image data to said first image capturing means;
said second optical system supplying image data to said second image capturing means; and
said processing means correcting a difference in image capturing position between said first optical system and said second optical system.

23. An image capturing apparatus as claimed in claim 2, wherein:
said image capturing apparatus includes a first optical system and a second optical system;
said first optical system supplying image data to said first image capturing means;
said second optical system supplying image data to said second image capturing means; and
said processing means correcting a difference in image capturing position between said first optical system and said second optical system.

24. An image capturing apparatus as claimed in claim 3, wherein:
said image capturing apparatus includes a first optical system and a second optical system;
said first optical system supplying image data to said first image capturing means;
said second optical system supplying image data to said second image capturing means; and
said processing means correcting a difference in image capturing position between said first optical system and said second optical system.

25. An image capturing apparatus according to claim 1, wherein:
said image capturing apparatus including first and second optical systems;
said first optical system supplying image data to said first image capturing device;
said second optical system supplying image data to said second image capturing device;
said first and second optical systems having lines of sight displaced a distance apart; and
said processing means including means for calculating a range to an object based on known parameters of said distance and a zoomed field angle.

26. An image capturing apparatus according to claim 1, wherein:
said image capturing apparatus including first and second optical systems;
said first optical system supplying image data to said first image capturing device;
said second optical system supplying image data to said second image capturing device;
said first and second optical systems having lines of sight displaced a distance apart; and
said processing means including means for adjusting at least one of a dimension and a lateral displacement of an image captured by one of said first and second image capturing devices to match an image captured by the other thereof.
